(19) United States
(12) Patent Application Publication
(10) Pub. No.: US 2019/0375245 A1
(43) Pub. Date: Dec. 12, 2019

(54) PNEUMATIC TIRE

(71) Applicant: Toyo Tire Corporation, Itami-shi (JP)

(72) Inventor: Tetsuji Miyazaki, Itami-shi (JP)

(73) Assignee: Toyo Tire Corporation, Itami-shi (JP)

(21) Appl. No.: 16/423,743

(22) Filed: May 28, 2019

(30) Foreign Application Priority Data
Jun. 6, 2018 (JP) 2018-108540

(51) Int. Cl. B60C 11/03; B60C 11/13; B60C 11/12

(52) U.S. Cl. CPC B60C 11/0332; B60C 11/0304; B60C 11/1323; B60C 2011/0388; B60C 11/1272; B60C 2011/0341; B60C 2011/1286; B60C 11/124

(57) ABSTRACT

A pneumatic tire in which a mounting orientation to a vehicle is designated, includes: the at least four land portions include an outside shoulder land portion, an outside quarter land portion, an inside shoulder land portion and an inside quarter land portion. A total ground contact area of the outside shoulder land portion and the outside quarter land portion is larger than a total ground contact area of the inside quarter land portion and the inside shoulder land portion. The outside quarter land portion has a first circumferential sipe extending in a tire circumferential direction. On the first circumferential sipe, a chamfered first inclined surface portion extending in the tire circumferential direction is provided between a vehicle outside inner wall of the first circumferential sipe and s surface of the outside quarter land portion.

### BACKGROUND OF THE INVENTION

### Field of the Invention

The present invention relates to a pneumatic tire including a tread portion.

### Description of the Related Art

Heretofore, it has been known that, during cornering, a ground contact pressure of a pneumatic tire becomes higher in a vehicle outside region on a tread portion, which faces a vehicle outside with a tire equator taken as a reference, than in a vehicle inside region on the tread portion, which faces a vehicle inside with the tire equator taken as a reference. Therefore, in order to improve steering stability performance, it is required to increase a ground contact area of the vehicle outside region, and to set rigidity of the tread portion high (refer to Patent Documents 1 to 4).

However, when the ground contact area of the tire is increased, and the rigidity of the tread portion is set high, then the tire becomes difficult to absorb irregularities of a road surface, and vibrations and noises are increased, leading to a decrease of riding comfort performance. That is, it can be said that the steering stability performance and the riding comfort performance are incompatible with each other. Patent Document 5 describes a pneumatic tire in which patterns of grooves, sipes and the like of a tread portion are designed in order to make incompatible performances compatible with each other; however, the pneumatic tire is not designed to make the steering stability performance and the riding comfort performance compatible with each other.

### PRIOR ART DOCUMENTS

### Patent Documents

Patent Document 1: JP-A-2007-161123

Patent Document 2: JP-A-2015-047977

Patent Document 3: JP-A-2013-133083

Patent Document 4: JP-A-2009-040156

Patent Document 5: WO2012/098895A1

### SUMMARY OF THE INVENTION

It is an object of the present invention to provide a pneumatic tire capable of improving the riding comfort performance while maintaining the steering stability performance.

In the present invention, the following pneumatic tire has been invented in order to achieve the above-described object.

That is, a pneumatic tire in which a mounting orientation to a vehicle is designated, comprising:

a tread portion provided with at least three main grooves extending in a tire circumferential direction and with at least four land portions defined by the main grooves,

wherein the at least four land portions include an outside shoulder land portion located on an outermost side when the pneumatic tire is mounted on the vehicle, an outside quarter land portion adjacent to an inside in a tire width direction of the outside shoulder land portion while sandwiching the main groove therebetween, an inside shoulder land portion located on an innermost side of the vehicle when the pneumatic tire is mounted on the vehicle, and an inside quarter land portion adjacent to an inside in a tire width direction of the inside shoulder land portion while sandwiching the main groove therebetween,

a total ground contact area of the outside shoulder land portion and the outside quarter land portion is larger than a total ground contact area of the inside quarter land portion and the inside shoulder land portion,

the outside quarter land portion has a first circumferential sipe extending in a tire circumferential direction, and

on the first circumferential sipe, a chamfered first inclined surface portion extending in the tire circumferential direction is provided between a vehicle outside inner wall of the first circumferential sipe and s surface of the outside quarter land portion.

Such a configuration is obtained on the basis of the following technical idea.

The total ground contact area of the outside shoulder land portion and the outside quarter land portion is made larger than the total ground contact area of the inside quarter land portion and the inside shoulder land portion. Accordingly, the rigidity of the vehicle outside region of the tread portion can be increased, and the steering stability performance can be improved. However, as mentioned above, the rigidity of the vehicle outside region of the tread portion is increased, whereby the tire becomes difficult to absorb irregularities of a road surface, and riding comfort performance decreases. Hence, in the above-described configuration, the circumferential sipes are provided on the outside quarter land portion, whereby the rigidity of the outside quarter land portion is partially reduced, and the riding comfort performance is improved. However, when the circumferential sipes are provided, the surface of the land portion on the peripheries of the circumferential sipes are subjected to a tumbling deformation by a lateral force during cornering, and the road holding properties are deteriorated to reduce the steering stability performance. Hence, in the above-described configuration, the chamfered first inclined surface portion extending in the tire circumferential direction is provided on the surface of the land portion on the peripheries of the circumferential sipes, especially between the vehicle outside inner wall and the surface of the land portion. In this way, rigidity to withstand the lateral force generated during cornering is ensured, and the steering stability performance is maintained. In this way, the riding comfort performance can be improved while maintaining the steering stability performance.

It is preferable that the chamfered inclined surface portion extending in the tire circumferential direction is not provided between a vehicle inside inner wall of the first circumferential sipe and the surface of the outside quarter land portion. A reason for the above is as follows. Even if the chamfered inclined surface portion is provided on the vehicle inside inner wall of the first circumferential sipe, such an effect of suppressing the tumbling deformation caused by the lateral force generated during cornering is insufficient, and an increase of the ground contact area rather contributes to the improvement of the steering stability performance.

It is preferable that the outside shoulder land portion has a second circumferential sipe extending in the tire circumferential direction, and

the second circumferential sipe is provided with a chamfered second inclined surface portion, which extends in the tire circumferential direction, between a vehicle outside inner wall of the second circumferential sipe and the surface of the outside shoulder land portion. In this way, the rigidity is also reduced in the outside shoulder land portion, and the riding comfort performance can be improved. Then, by providing the second inclined surface portion, the rigidity to withstand the lateral force generated during cornering is ensured, and the steering stability performance can be maintained.

It is preferable that the chamfered inclined surface portion extending in the tire circumferential direction is not provided between a vehicle inside inner wall of the second circumferential sipe and the surface of the outside shoulder land portion. A reason for the above is as follows. Even if the chamfered inclined surface portion is provided on the vehicle inside inner wall of the second circumferential sipe, such an effect of suppressing the tumbling deformation caused by the lateral force generated during cornering is insufficient, and the increase of the ground contact area rather contributes to the improvement of the steering stability performance.

It is preferable that a width of a sipe surface including the first inclined surface portion on the first circumferential sipe is larger than a width of sipe surface including the second inclined surface portion on the second circumferential sipe. On the outside quarter land portion located more on the inside in the tire width direction than the outside shoulder land portion, the ground contact pressure tends to be higher than that of the outside shoulder land portion, and the outside quarter land portion is apt to be affected by the irregularities of the road surface. Hence, the width of the sipe surface including the inclined surface portion on the outside quarter land portion is made larger than the width of the sipe surface including the inclined surface portion on the outside shoulder land portion, whereby the rigidity of the outside quarter land portion is reduced preferentially to the rigidity of the outside shoulder land portion, whereby the riding comfort performance can be improved.

It is preferable that the circumferential sipe extending in the tire circumferential direction is not formed on at least one of the inside shoulder land portion and the inside quarter land portion. A reason for this is as follows. The total ground contact area of the inside quarter land portion and the inside shoulder land portion is smaller than the total ground contact area of the outside shoulder land portion and the outside quarter land portion. Accordingly, the rigidities of the inside quarter land portion and the inside shoulder land portion are sufficiently lower than the rigidities of the outside shoulder land portion and the outside quarter land portion. Therefore, at least either one of the inside shoulder land portion and the inside quarter land portion can ensure the road holding properties without any circumferential sipe.

It is preferable that a plurality of the lateral sipes extending in the tire width direction are formed at intervals in the circumferential direction on at least one of the inside shoulder land portion and the inside quarter land portion. When it is desired to improve the road holding properties by reducing the rigidities on the inside quarter land portion and the inside shoulder land portion, which have small ground contact areas, if lateral sipes extending in the tire width direction are formed, then the rigidities can be appropriately reduced to improve the road holding properties.

### BRIEF DESCRIPTION OF THE DRAWINGS

FIG. 1 is a development view illustrating an example of a tread surface of a pneumatic tire according to the present invention;

FIG. 2 is an enlarged view and cross-sectional view of an outside shoulder land portion and an outside quarter land portion.

### DETAILED DESCRIPTION OF THE PREFERRED EMBODIMENTS

Hereinafter, an embodiment in a pneumatic tire according to the present invention will be described with reference to the drawings. Note that, in the respective drawings, dimensional ratios in the drawings and actual dimensional ratios do not necessarily coincide with each other, and moreover, dimensional ratios between the respective drawings do not necessarily coincide with one another.

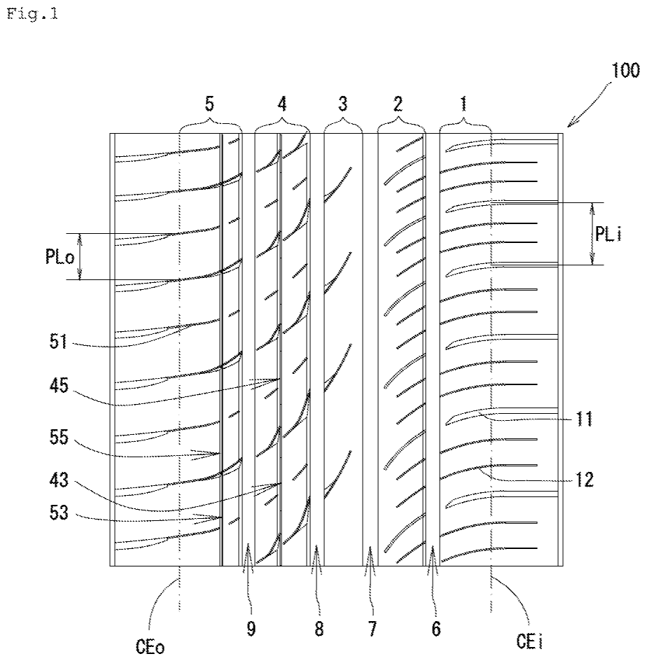

FIG. 1 is a plan view illustrating an embodiment of a tread portion 100 of the pneumatic tire according to the present invention. The tread portion 100 includes: four main grooves 6 to 9 extending in the tire circumferential direction; and five land portions 1 to 5 defined by the main grooves 6 to 9. In this embodiment, a mounting orientation of the pneumatic tire to a vehicle is designated, and the five land portions 1 to 5 are composed of an inside shoulder land portion 1, an inside quarter land portion 2, a center land portion 3, an outside quarter land portion 4 and an outside shoulder land portion 5. The outside shoulder land portion 5 is located on an outermost side of the vehicle when the pneumatic tire is mounted on the vehicle, and is defined by a ground contact end CEo on the vehicle outside and the main groove 9. The outside quarter land portion 4 is adjacent to an inside in a tire width direction of the outside shoulder land portion 5 while sandwiching the main groove 9 therebetween. The inside shoulder land portion 1 is located on an innermost side of the vehicle when the pneumatic tire is mounted on the vehicle, and is defined by a ground contact end CEi on the vehicle inside and the main groove 6. The inside quarter land portion 2 is adjacent to an inside in a tire width direction of the inside shoulder land portion 1 while sandwiching the main groove 6 therebetween. The center land portion 3 is adjacent to insides in tire width directions of the quarter land portions 2 and 4 while sandwiching the main grooves 7 and 8 therebetween. The respective land portions 1 to 5 are composed of ribs continuously extending in the tire circumferential direction, and on each of the ribs, a plurality of lateral sipes extending in the tire width direction are formed at intervals in the tire circumferential direction. It is not necessary that a direction where the main grooves extend be completely coincide with the tire circumferential direction. It is preferable that the number of main grooves be three or more, and that the number of land portions be four or more. In the case where the number of land portions is four, the center land portion is not provided.

The ground contact ends CEi and CEo are outermost positions of the tread portion 100 in the tire width direction when the tire assembled to a normal rim and applied with a normal internal pressure and a normal load is grounded to a flat road surface. The normal rim is a rim determined for each of tires by a standard on which the tires are based, the standard being included in a system of standards. For example, the normal rim is a reference rim defined by Japan Automobile Tyre Manufacturers Association (JATMA), “Design Rim” defined by The Tire and Rim Association, Inc. (TRA), or “Measuring Rim” defined by The European Tyre and Rim Technical Organization (ETRTO). The normal internal pressure is an air pressure defined for each of the tires by the standard on which the tires are based, the standard being included in the system of standards. For example, the normal internal pressure is a maximum air pressure defined by JATMA, a maximum value described in the table “TIRE LOAD LIMITS AT VARIOUS COLD INFLATION PRESSURES” in TRA, or “INFLATION PRESSURE” defined by ETRTO. The normal load is a load determined for each of the tires by the standard on which the tires are based, the standard being included in the system of standards. For example, the normal load is a maximum load capacity defined by JATMA, a maximum value described in the above table of TRA, or “LOAD CAPACITY” defined by ETRTO.

A display to designate the mounting orientation of the pneumatic tire to the vehicle is provided, for example, on a sidewall portion. Specifically, it is conceivable to provide a display (for example, OUTSIDE), which tells that the sidewall portion disposed on the vehicle outside when the pneumatic tire is mounted on the vehicle shall face the vehicle outside, on an outer surface of the sidewall portion. Alternatively or additionally, it is conceivable to provide a display (for example, INSIDE), which tells that the sidewall portion disposed on the vehicle inside when the pneumatic tire is mounted on the vehicle shall face the vehicle inside, on the outer surface of the sidewall portion.

In this embodiment, a total ground contact area of the outside shoulder land portion 5 and the outside quarter land portion 4 is larger than a total ground contact area of the inside quarter land portion 2 and the inside shoulder land portion 1. In this way, the rigidity of the vehicle outside region of the tread portion can be increased, and the steering stability performance can be improved. The ground contact area of the land portion such as the outside shoulder land portion 5 is measured by a virtual ground contact surface in which the sipes and inclined surface portions to be described later, which are provided on the land portion, are filled.

It is preferable that a sum of a ground contact area ratio of the outside shoulder land portion 5 and a ground contact area ratio of the outside quarter land portion 4 be larger than a sum of a ground contact area ratio of the inside quarter land portion 2 and a ground contact area ratio of the inside shoulder land portion 1 by 5% or more. In this way, the rigidity of the vehicle outside region of the tread portion is increased sufficiently, and the steering stability performance can be improved effectively. The ground contact area ratio is calculated by an expression: ground contact area of land portion/(ground contact area of all land portions+area of all groove portions)×100 (unit: %). The area of the groove portions is an area measured on a virtual ground contact surface in which the main grooves and the lateral grooves are filled.

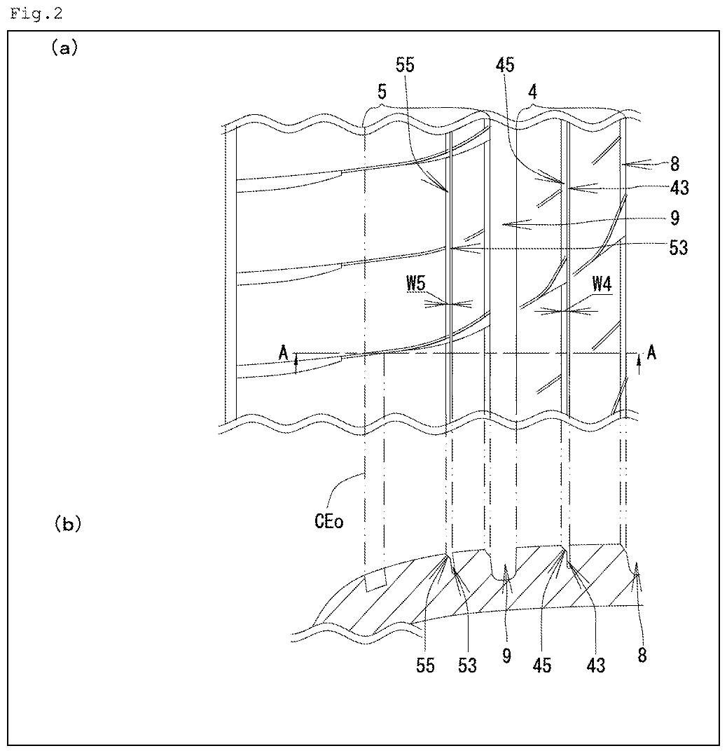

FIG. 2(a) is an enlarged view of the outside shoulder land portion 5 and the outside quarter land portion 4 in FIG. 1, and FIG. 2(b) is a cross-sectional view taken along a line A-A of FIG. 2(a). As viewed in FIGS. 2(a) and 2(b), the outside quarter land portion 4 has a first circumferential sipe 43 extending in the tire circumferential direction, whereby rigidity of the outside quarter land portion 4 having high rigidity is partially reduced, and the riding comfort performance is improved. Then, a chamfered first inclined surface portion 45 extending in the tire circumferential direction is provided between a vehicle outside inner wall and land portion surface of the first circumferential sipe 43. In this way, rigidity to withstand the lateral force generated during cornering is ensured, and the steering stability performance is maintained. In this way, the riding comfort performance can be improved while maintaining the steering stability performance.

A position in a tire width direction of the first circumferential sipe 43, a sipe width and sipe depth thereof, and a width and inclination angle of the first inclined surface portion 45, which are along the surface of the land portion, are designed in consideration of the steering stability performance and the riding comfort performance. The sipe width of the first circumferential sipe 43 is 2.5 mm or less, preferably 2 mm or less, more preferably 1.6 mm or less, and it is preferable that the position the first circumferential sipe 43 be a center in the tire width direction of the outside quarter land portion 4. A width in a tire width direction of the first inclined surface portion 45 is constant in the tire circumferential direction, and preferably, is 3 mm or less. This is because, when the width exceeds 3 mm, an effect of ensuring rigidity to withstand a lateral force generated during cornering may be reduced as the ground contact area decreases.

In this embodiment, the chamfered inclined surface portion extending in the tire circumferential direction is not provided between a vehicle inside inner wall of the first circumferential sipe 43 and the surface of the land portion. The vehicle inside inner wall of the first circumferential sipe 43 is connected to the surface of the land portion while forming one corner portion therewith. Even if the chamfered inclined surface portion is provided on the vehicle inside inner wall of the first circumferential sipe, an effect of suppressing a tumbling deformation caused by the lateral force generated during cornering is insufficient, and an increase of the ground contact area rather contributes to the improvement of the steering stability performance, and accordingly, such a configuration as above is preferable.

In this embodiment, the outside shoulder land portion 5 has a second circumferential sipe 53 extending in the tire circumferential direction, and the second circumferential sipe 53 is provided with a chamfered second inclined surface portion 55, which extends in the tire circumferential direction, between a vehicle outside inner wall of the second circumferential sipe 53 and the surface of the outside shoulder land portion 5. In this way, the rigidity is also reduced in the outside shoulder land portion 5, and the riding comfort performance can be improved. Then, by providing the second inclined surface portion 55, the rigidity to withstand the lateral force generated during cornering is ensured, and the steering stability performance can be maintained.

Moreover, a position in a tire width direction of the second circumferential sipe 53, a sipe width and sipe depth thereof, and a width and inclination angle of the second inclined surface portion 55, which are along the surface of the land portion, are designed in consideration of the steering stability performance and the riding comfort performance. It is recommended that the position in the tire width direction of the second circumferential sipe 53 be a position from the main groove 9 toward an inside of the land portion by an amount of 25 to 35% when a width of the outside shoulder land portion 5 (in other words, an interval between the main groove 9 and the ground contact end CEo) is 100%. Reasons for this are as follows. When this width falls below 25%, an interval between the second circumferential sipe 53 and the main groove 9 so narrow as to reduce the rigidity, and when the width exceeds 35%, road holding properties on the ground contact end of the outside shoulder land portion 5 decrease.

In this embodiment, the chamfered inclined surface portion extending in the tire circumferential direction is not provided between a vehicle inside inner wall of the second circumferential sipe 53 and the surface of the land portion. The vehicle inside inner wall of the second circumferential sipe 53 is connected to the surface of the land portion while forming one corner portion therewith. Even if the chamfered inclined surface portion is provided on the vehicle inside inner wall of the second circumferential sipe, such an effect of suppressing the tumbling deformation caused by the lateral force generated during cornering is insufficient, and an increase of the ground contact area rather contributes to the improvement of the steering stability performance, and accordingly, such a configuration as above is preferable.

Moreover, with regard to the outside quarter land portion 4 located more on the inside in the tire width direction than the outside shoulder land portion 5, a ground contact pressure thereof is higher than that of the outside shoulder land portion 5, where an irregular state of the road surface is apt to affect the riding comfort. Hence, a sipe surface width W4 of the first circumferential sipe 43 including the first inclined surface portion 45 on the outside quarter land portion 4 is made larger than a sipe surface width W5 of the second circumferential sipe 53 including the second inclined surface portion 55 on the outside shoulder land portion 5, whereby the rigidity of the outside quarter land portion 4 is reduced preferentially to that of the outside shoulder land portion 5, whereby the riding comfort performance can be improved. It is preferable that the sipe surface width W4 be, for example, 1.1 times or more the sipe surface width W5.

A circumferential sipe extending in the circumferential direction is not formed on at least one (both in this embodiment) of the inside shoulder land portion 1 and the inside quarter land portion 2. In this embodiment, the total ground contact area of the inside quarter land portion 2 and the inside shoulder land portion 1 is smaller than the total ground contact area of the outside shoulder land portion 5 and the outside quarter land portion 4. Accordingly, the rigidities of the inside quarter land portion 2 and the inside shoulder land portion 1 are sufficiently lower than the rigidities of the outside shoulder land portion 5 and the outside quarter land portion 4, where the road holding properties can be ensured without any circumferential sipe.

In this embodiment, in order to improve the road holding properties by appropriately reducing the rigidity, the plurality of lateral sipes extending in the tire width direction are formed at intervals in the tire circumferential direction on the respective ribs which constitute the land portions. At this time, in order to obtain desired rigidity, the number of pitches of the lateral sipes and the lateral grooves, which are formed on the respective ribs, just needs to be adjusted. The lateral grooves refer to those in which a groove width exceeds 2 mm, and the lateral sipes refer to those in which a sipe width is equal to or less than 2 mm. At this time, when circumferential intervals (pitch lengths) of the lateral sipes and the lateral grooves on the respective ribs are adjusted so that the number of pitches in the vehicle outside region and the number of pitches in the vehicle inside region are different from each other, then a pitch noise dispersion effect is obtained.

This is described along this embodiment. On the rib of the inside shoulder land portion 1 located on the innermost side of the vehicle when the pneumatic tire is mounted on the vehicle, the lateral grooves 11 and the lateral sipes 12 are formed, and the lateral grooves 11 are arranged at a first pitch length PLi. On the rib of the outside shoulder land portion 5 located on the outermost side of the vehicle when the pneumatic tire is mounted on the vehicle, the lateral sipes 51 are formed, and the lateral sipes 51 are arranged at a second pitch length PLo. The first pitch length PLi of the inside shoulder land portion 1 is larger than the second pitch length PLo of the outside shoulder land portion 5. However, the lateral sipes 12 are formed between the lateral grooves 11, whereby the rib rigidity of the vehicle inside region is appropriately reduced, and the riding comfort performance is improved. With regard to the outside shoulder land portion 5, though the number of pitches is larger therein than in the inside shoulder land portion 1, the lateral grooves are not formed on the rib thereof, and the lateral sipes 51 of which number is smaller than in the inside shoulder land portion 1 are formed thereon. Accordingly, the rib rigidity of the vehicle outside region is ensured sufficiently, and the steering stability performance is maintained. Then, since the first pitch length PLi on the inside shoulder land portion 1 and the second pitch length PLo on the outside shoulder land portion 5 are different from each other, the pitch noise dispersion effect is obtained.

The pneumatic tire according to the present invention can be composed similarly to usual pneumatic tires except that the tread portion is composed as described above, and any of a material, a shape, a structure and a manufacturing method, which are conventionally known, can be adopted. Though not illustrated, the pneumatic tire of this embodiment includes: a pair of bead portions; sidewall portions, each of which extends outside in the tire diameter direction from each of the bead portions; and a tread portion continuous with outside ends in the tire diameter direction of the respective sidewall portions.

The present invention is not limited to the above-mentioned embodiments, and is improvable and modifiable in various ways within the scope without departing from the spirit of the present invention.

What is claimed is:

1. A pneumatic tire in which a mounting orientation to a vehicle is designated, comprising:
a tread portion provided with at least three main grooves extending in a tire circumferential direction and with at least four land portions defined by the main grooves,
wherein the at least four land portions include an outside shoulder land portion located on an outermost side when the pneumatic tire is mounted on the vehicle, an outside quarter land portion adjacent to an inside in a tire width direction of the outside shoulder land portion while sandwiching the main groove therebetween, an inside shoulder land portion located on an innermost side of the vehicle when the pneumatic tire is mounted on the vehicle, and an inside quarter land portion adjacent to an inside in a tire width direction of the inside shoulder land portion while sandwiching the main groove therebetween,
a total ground contact area of the outside shoulder land portion and the outside quarter land portion is larger than a total ground contact area of the inside quarter land portion and the inside shoulder land portion,
the outside quarter land portion has a first circumferential sipe extending in a tire circumferential direction, and
on the first circumferential sipe, a chamfered first inclined surface portion extending in the tire circumferential direction is provided between a vehicle outside inner wall of the first circumferential sipe and s surface of the outside quarter land portion.

2. The pneumatic tire according to claim 1, wherein the chamfered inclined surface portion extending in the tire circumferential direction is not provided between a vehicle inside inner wall of the first circumferential sipe and the surface of the outside quarter land portion.

3. The pneumatic tire according to claim 1, wherein the outside shoulder land portion has a second circumferential sipe extending in the tire circumferential direction, and
the second circumferential sipe is provided with a chamfered second inclined surface portion, which extends in the tire circumferential direction, between a vehicle outside inner wall of the second circumferential sipe and the surface of the outside shoulder land portion.

4. The pneumatic tire according to claim 3, wherein the chamfered inclined surface portion extending in the tire circumferential direction is not provided between a vehicle inside inner wall of the second circumferential sipe and the surface of the outside shoulder land portion.

5. The pneumatic tire according to claim 3, wherein a width of a sipe surface including the first inclined surface portion on the first circumferential sipe is larger than a width of sipe surface including the second inclined surface portion on the second circumferential sipe.

6. The pneumatic tire according to claim 3, wherein a position in a tire width direction of the second circumferential sipe is a position from the main groove adjacent to the inside in the tire width direction of the outside shoulder land portion toward an inside of the land portion by an amount of 25 to 35% when a width of the outside shoulder land portion is 100%.

7. The pneumatic tire according to claim 1, wherein the circumferential sipe extending in the tire circumferential direction is not formed on at least one of the inside shoulder land portion and the inside quarter land portion.

8. The pneumatic tire according to claim 1, wherein a plurality of the lateral sipes extending in the tire width direction are formed at intervals in the circumferential direction on at least one of the inside shoulder land portion and the inside quarter land portion.

9. The pneumatic tire according to claim 1, wherein
lateral grooves are arranged on a rib of the inside shoulder land portion at a first pitch length in the tire circumferential direction, and
lateral sipes are arranged on a rib of the outside shoulder land portion at a second pitch length in the tire circumferential direction, and the first pitch length of the rib of the inside shoulder land portion is larger than the second pitch length of the rib of the outside shoulder land portion.
